(19) United States
(12) Patent Application Publication
(10) Pub. No.: US 2011/0246260 A1
(43) Pub. Date: Oct. 6, 2011

(54) SYSTEM AND METHOD FOR ROUTING MARKETING OPPORTUNITIES TO SALES AGENTS

(76) Inventors: James Gilbert, Niwot, CO (US); Barry Neu, Longmont, CO (US); Albert A. Prast, Winter Park, FL (US); Peter Antunes, Orlando, FL (US)

(21) Appl. No.: 12/964,537

(22) Filed: Dec. 9, 2010

Related U.S. Application Data
(60) Provisional application No. 61/354,154, filed on Jun. 11, 2010.
(60) Provisional application No. 61/285,819, filed on Dec. 11, 2009.
(60) Provisional application No. 61/297,657, filed on Jan. 22, 2010.

(51) Int. Cl. G06Q 10/00

(52) U.S. Cl. 705/7.32

(57) ABSTRACT

A system and method for routing marketing opportunities to sales agents is described. One embodiment receives a plurality of consumer responses to marketing invitations; tracks, in a database, attributes of the consumers associated with the plurality of consumer responses, attributes of a plurality of sales agents with whom the consumers interact, product-related attributes, and transitions of the consumers among a plurality of consumer states; analyzes the information in the database to identify one or more factors that contributed to at least one transition; generates one or more routing rules based on the one or more factors; receives a new consumer response to a marketing invitation; and routes the new consumer response to a particular sales agent among the plurality of sales agents based on the one or more routing rules.

### PRIORITY

The present application claims priority from commonly owned and assigned provisional application No. 61/354,154 (Attorney Docket No. CONN-002/00US), filed Jun. 11, 2010; provisional application No. 61/285,819 (Attorney Docket No. CONN-001/00US), filed Dec. 11, 2009; and provisional application No. 61/297,657 (Attorney Docket No. CONN-001/01US), filed Jan. 22, 2010; each of which is entitled “Computerized System And Method For Optimizing Acquisition Of Consumers,” and each of which is incorporated herein by reference in its entirety and for all purposes.

### FIELD OF THE INVENTION

The present invention relates generally to computerized marketing and sales systems and, more particularly, to a computerized system and method for routing marketing opportunities to sales agents.

### BACKGROUND OF THE INVENTION

Computer systems employed to acquire and retain customers are known. Conventional systems allow their users to structure marketing campaigns to reach likely consumers of the products and/or services being marketed. In these systems, opportunities for sales or “leads” are identified, evaluated and addressed through a series of organized tasks and activities structured and sequenced to increase the likelihood that the lead results in a sale. In many sales cycles, a potential consumer of the product or service transitions from a number of “states” from the initial time the lead is known to the consummation of the sale. The process continues after the initial sale or formation of a business relationship, and a similar process is utilized to sell additional products and services to the existing customer and/or to retain the customer—particularly for services offerings or products involving maintenance and support relationships. The process is dynamic as consumer preferences, competition, externalities and a litany of other factors influence the effectiveness of the campaign and the sales approach used to most effectively mature leads into future states and ultimately sales.

To this point, conventional software systems have not aligned the users of the computer systems (i.e., sales agents) with the leads nor optimized and predicted the likelihood that consumers of a particular type or segment will mature from one state to another based on the relevant tasks and activities. Accordingly, there is a need for an effective system and method to address these deficiencies.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a system and method for routing marketing opportunities to sales agents. One illustrative embodiment is a system for routing marketing opportunities to sales agents, the system comprising at least one processor and a memory connected with the at least one processor, the memory containing a plurality of program instructions configured to cause the at least one processor to: receive a plurality of consumer responses to marketing invitations; track, in a database, attributes of the consumers associated with the plurality of consumer responses, attributes of a plurality of sales agents with whom the consumers interact, product-related attributes, and transitions of the consumers among a plurality of consumer states, each of the plurality of consumer states corresponding to a particular situation in a sales lifecycle; identify, by analyzing information in the database, one or more factors that contributed to at least one transition; generate one or more routing rules based on the one or more factors; receive a new consumer response to a marketing invitation; and route the new consumer response to a particular sales agent among the plurality of sales agents based on the one or more routing rules.

Another illustrative embodiment is a method for routing marketing sales opportunities to sales agents, the method comprising receiving a plurality of consumer responses to marketing invitations; tracking, in a database stored in a memory, attributes of the consumers associated with the plurality of consumer responses, attributes of a plurality of sales agents with whom the consumers interact, product-related attributes, and transitions of the consumers among a plurality of consumer states, each of the plurality of consumer states corresponding to a particular situation in a sales lifecycle; identifying, by using a processor to analyze information in the database, one or more factors that contributed to at least one transition; generating one or more routing rules based on the one or more factors; receiving a new consumer response to a marketing invitation; and routing the new consumer response to a particular sales agent among the plurality of sales agents based on the one or more routing rules.

The methods of the invention can also be embodied, at least in part, as executable program instructions stored on a computer-readable storage medium.

These and other embodiments are described in further detail herein.

### BRIEF DESCRIPTION OF THE DRAWINGS

Various objects and advantages and a more complete understanding of the present invention are apparent and more readily appreciated by reference to the following Detailed Description when taken in conjunction with the accompanying Drawings, wherein:

FIG. 1 is a block diagram of a suitable computing system environment for use in implementing various illustrative embodiments of the present invention;

FIG. 2 is a flowchart representative of a method for advancing marketing opportunities to sales in accordance with an illustrative embodiment of the invention;

FIG. 3 is a user interface of a computer program illustrating a request for the publication of correlated predictions in response to a query in accordance with an illustrative embodiment of the invention;

FIG. 4 is a user interface of a computer program illustrating the publication of predictions in response to the query submitted via the user interface illustrated in FIG. 3, in accordance with an illustrative embodiment of the invention;

FIG. 5 is a high-level block diagram of an environment in which certain embodiments of the invention can be implemented;

FIG. 6 is a diagram showing the architecture of an application that performs a routing operation in accordance with an illustrative embodiment of the invention;

FIG. 7 is a flowchart of a method for routing a marketing opportunity to a sales agent in accordance with an illustrative embodiment of the invention;

FIG. 8 is a diagram showing a system for synthesizing data into independent variables that can be used to predict future state transitions in accordance with an illustrative embodiment of the invention; and

FIG. 9 is a diagram showing a system for synthesizing data for use by a routing service in assigning sales leads to sales agents in accordance with an illustrative embodiment of the invention.

### DETAILED DESCRIPTION

Various illustrative embodiments of the present invention provide a system and method for routing marketing opportunities to sales agents.

One illustrative embodiment is a method for routing marketing opportunities to sales agents, including initially receiving a plurality of consumer responses to marketing invitations. The method also includes tracking attributes of consumers associated with the consumer responses, attributes of sales agents with whom the consumers interact, product-related attributes, and transitions of the consumers among various consumer states that correspond to particular situations in a sales lifecycle. The method further includes identifying one or more factors that contributed to a transition, and generating routing rules based on the one or more factors. The method further includes receiving a new consumer response to a marketing invitation and using the routing rules to route the new consumer response to a particular sales agent.

Another illustrative embodiment is embodied as one or more computer-readable media having computer-usable components for receiving a plurality of consumer responses to marketing invitations; tracking attributes of consumers associated with the consumer responses, attributes of sales agents with whom the consumers interact, product-related attributes, and transitions of the consumers among various consumer states that correspond to particular situations in a sales lifecycle; identifying one or more factors that contributed to a transition; generating routing rules based on the one or more factors; receiving a new consumer response to a marketing invitation; and using the routing rules to route the new consumer response to a particular sales agent.

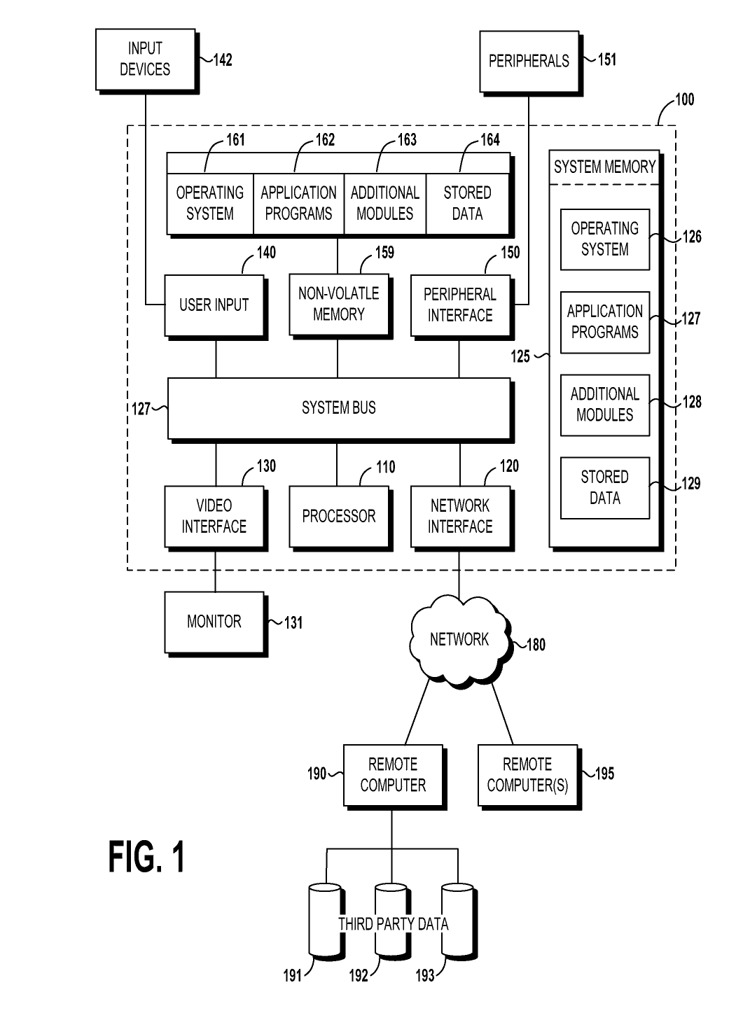

FIG. 1 illustrates an example of a suitable computing system environment in which the invention may be implemented. The computing environment is representative and not limiting to the use and design of the invention. No relationship or interdependency of the elements of the representative operating environment is intended. A number of other specific and general purpose computing environments may be used with the present invention including client-server devices, personal computers, micro-processing devices, virtual machines, cloud computing environments and a variety of centralized and distributed computing environments including one or more of the systems described above or shown in FIG. 1.

The invention is generally set forth in computer-executable instructions in the form of modules or applications being executed by the computer. Known structures are employed and executed across the elements of the computing environment.

With reference to FIG. 1, an exemplary system includes a general purpose computing device in the form of a computer 100. Components of computer 100 include a processor 110, a network interface 120, a system memory 125, and a system bus 127 that couples various system components including the system memory to the processor 110. The system bus 127 may be a memory bus, a peripheral bus, a local bus or a variety of other bus structures.

Computer 100 typically includes a variety of computer readable media. Computer readable media can be any available media that can be accessed by computer 100 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or any other information delivery media. By way of example, and not limitation, communication media includes wired media such as a wired network or direct wired connection, and wireless media such as acoustic, RF, infrared and other wireless media. Combinations of any of the above should also be included within the scope of computer readable media.

The system memory 125 includes computer storage media in the form of volatile and/or nonvolatile memory such as read only memory (ROM) and random access memory (RAM) and a basic input/output system (BIOS) to transfer information between elements within computer 100, that is typically stored in ROM. The RAM typically contains data and/or program modules that are immediately accessible to and/or presently being operated on by processor 110. By way of example, FIG. 1 illustrates an operating system 126, application programs 127, additional modules 128, and stored data 129.

The computer 100 may also include other non-volatile computer storage media 159 which may include non-removable, nonvolatile magnetic media, disk drives, magnetic tape cassettes, flash memory cards, digital video disks, digital video tape, Bernoulli cartridges, solid state RAM, solid state ROM, and the like. The computer storage media discussed above and illustrated in FIG. 1 provide storage of computer readable instructions, data structures, program modules and other data for the computer 100. In FIG. 1, for example, representative memory 159 of nonvolatile memory is illustrated as storing operating system 161, application programs 162, additional program modules 163, and stored data 164. Note that these components can either be the same as or different from operating system 126, application programs 127, additional program modules 128, and stored data 129. A user may enter commands and information into the computer 100 through input devices 142 (i.e., keyboards, mouse, etc.). These and other input devices are often connected to the processor 110 through a user input interface 140 that is coupled to the system bus 127. A monitor 131 or other type of display device is also connected to the system bus 127 via an interface such as a video interface 130. In addition to the monitor 131, computers may also include other peripheral output devices 151 (i.e., a printer), which may be connected through an output peripheral interface 150.

The computer 100 may operate in a networked environment using logical connections to one or more remote computers, such as a remote computers 190 and 195. The remote computers 190, 195 may be a personal computer, a server, a router, a network PC, a peer device or other common network node, and typically includes many or all of the elements described above relative to the computer 100, although only a memory storage device has been illustrated in FIG. 1. The logical connections depicted in FIG. 1 include a network 180 such as a local area network (LAN) or a wide area network (WAN), but may also include other networks. Such networking environments are commonplace in offices, enterprise-wide computer networks, intranets and the Internet. Remote computer 190 may be coupled with a variety of third party data stores 191, 192, 193, as described in greater detail below.

Although many other internal components of the computer 100 are not shown, those of ordinary skill in the art will appreciate that such components and the interconnection are well known. Accordingly, additional details concerning the internal construction of the computer 100 need not be disclosed in connection with the present invention.

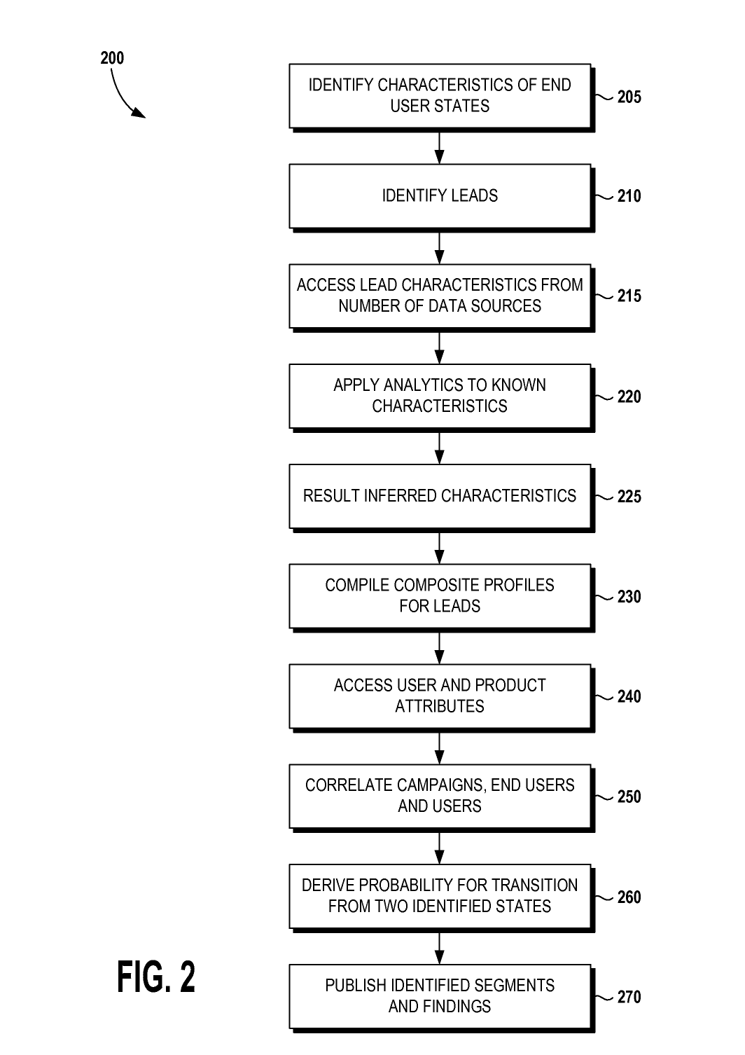

FIG. 2 sets forth a flowchart representative of a method for selectively aligning users of the system with consumers of products and thus selecting the activities to improve the likelihood of progressing the consumer from one state in the sales process to the next state and ultimately to a successful commercial transaction and relationship. The process is identified generally with reference numeral 200.

Initially, at step 205, the characteristics of the various consumer states are identified. In embodiments, each consumer of the product or service progresses through a series of states. One example of a pathway of consumer states includes the following states: (a) an initial interest in the product or service or pre-qualification of a consumer, (b) a transfer of core information regarding the product or service to the consumer, (c) an initial trial of a product or short term enrollment in a service, (d) an initial sale of the product or meaningful provision of the service, (e) an upsale of additional product or services, (f) maintenance and support of the consumer relationship; and (g) retention of the consumer over a period of time. Each consumer state includes a number of characteristics that are stored, for example, as data elements in a referential database such as Stored Data 129. By identifying each of the various states, sales activities may be associated with the consumer state before and after the activity.

Next, at step 210, leads are identified and accessed. A lead is a consumer or business with a qualified interest for a particular product or service. By way of example, leads may be identified by accessing a database containing requests for information about a particularly product or service. In other cases, the core characteristics of the sales and marketing campaign may be applied to qualify (or filter) an initial list of leads. In one example, a particular campaign may be targeted to a specific region (i.e., geography: the Southeast United States), a particular medium (i.e., mode: Internet), a target segment type (i.e., status: families with young children), and target demographics (i.e., income targets: $50,000+, work status: retired, etc.). In such cases, the campaign may be defined by the attributes of the generalized segment targeted by the campaign. The campaign attributes may be applied as an initial pass or filter to the list of leads initially provided so that the qualification process may be complete prior to consumption by the system and methods described herein.

In embodiments, each lead includes one or more attributes of consumer-identifying information including, by way of example, a name or other identifier, a service plan number or product identifier for services/products of stated interest, a phone number or another consumer-specific attribute. The attributes form an initial profile for the consumer lead. Using the attributes obtained at step 210, the system obtains additional attributes for each of the leads at step 215 by accessing available internal data sources such as member directories (if the lead has an existing data set by virtue of prior interactions with the provider of the good or services) or other data acquired. Known systems and methods for merging disparate data sets are employed.

Also, a number of web services (or other data gathering methods) are utilized to access third party data sources in the public domain (such as through network 180 in communication with remote computers 190 and data sources 191, 192, 193). These third party data sources include government records such as real property records, census data, death master lists and the like. The initial lead attributes may be supplemented to include additional demographic profile information such as gender, age and geographic location, and expressed preferences or needs including product-interest, requests to call at specific times, and language preferences.

Next, at step 220, analytics are applied to the known lead characteristics accessed at step 215. In an embodiment, a standardized rule set may be applied to the known attributes to infer and result additional attributes at step 225. By way of example, ZIP code information may be used to access population information and segmentation for attributes such as race, median household income (and income segmentation) and average home value through known web services such as the ESRI GIS information databases. Each of the inferred characteristics is stored as an attribute for the lead. As used herein, inferences may initially result expected values for each consumer, and these inferences may later be validated or adjusted through an iterative process as additional information is known about the lead. Collectively, the known and inferred attributes constitute a lead profile of attributes consumed by the correlative analytics described below.

At step 230, product (or service) attributes, system user (or sales) attributes and activity information attributes are obtained. In an embodiment, product attributes include a product-specific identifier, a price or price range for each product, and the feature(s) found in each product or service. In embodiments, attributes for a number of products are accessed for consumption by the correlative analytics described below.

Likewise, attributes of the sales agent (or system user) are also accessed at step 230. In embodiments, system user attributes include a user identifier, ZIP code, gender, and historical state transition rates between identified states for a number of products and consumer categories. By way of example, the transition rate may include the number of closed or consummated sales for Products A, B, and C for demographic categories (i.e., combination of age and gender), or social categories (i.e., status: soccer moms) or other categories or characteristics of consumers.

Historical activity information attributes include activity data associated with each product and each sales agent. For example, the triggering events (display, search, voice, mailings) and points of contact (toll free number, chart uniform resource indicator (URI), website uniform resource locator (URL), etc.) are included in the sales activity dataset. In embodiments, each activity is defined by the state of the consumer before and after the activity. Collectively, the product, sales agent, and activity information attributes form a dataset that is consumed by the correlative analytics along with the lead profiles described above.

At step 250, correlations are made among attributes of the leads, product/service, sales agent and sales activity. Regression analysis is employed to determine which of the attributes is the best predictor of a successful transition of the lead from one identified state to the next identified state in the sales and retention process. More specifically, in embodiments, the dependent variables in the regression analysis are the state transitions, and the independent variables are each of the various attributes (and combinations therein) of the lead, sales agent, product and sales actions and activities. Thus, forecasting of the impact on state transitions is conducted and the probability of transitioning a consumer from one state to the next depending on one or more attributes is derived and resulted at step 260. The results of the correlation are predictive and allow the system to optimize and align the sales agents, sales actions and products to improve conversion of the lead to the next state.

As known in the regression analysis, a regression equation is employed and resolved to correlate each of the various attributes to the state transition. In embodiments, regression diagnostics confirm goodness of fit of the regression model to determine the validity of the regression model. For example, in embodiments, the R-squared goodness of fit analysis may be employed. Provided a sufficient goodness of fit, the predictions are validated for purposes of the predictions and sales allocations and adjustments described below. Ultimately, the predictions of step 260 are published to sales agents and campaign managers at step 270 provided the correlations are deemed meaningful.

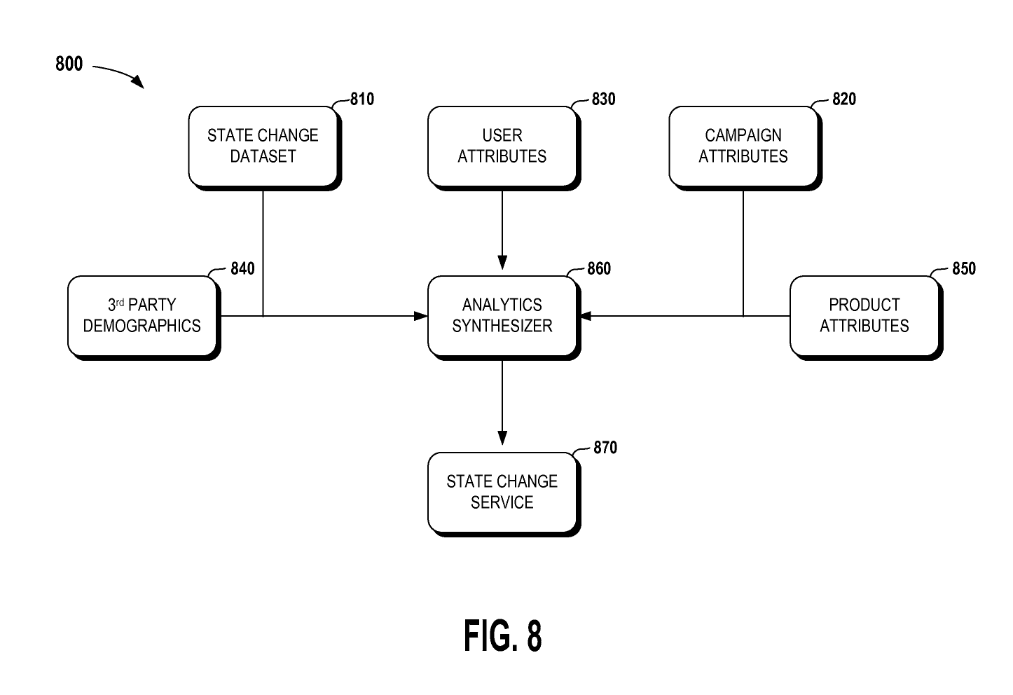

In one illustrative embodiment, a system 800 as shown in FIG. 8 may be used to intersect the profiles likely to transition to an ideal next state and the profiles that progress to other states (e.g. lost opportunity). The system 800 also derives a probability for a particular state transition and correlates related campaign attributes, end-user and user profiles. The system 800 thus demonstrates, by way of example, the analysis of state transitions (e.g. qualified to closed sales) to understand the conditions that triggered the state change and synthesis of the data into independent variables that a system can utilize to predict the likelihood of a state change given a given end-user with a particular profile and interest for a particular product or service. The system 800 consists of a State Change Dataset 810, Campaign Attributes 820, User Attributes 830, 3rd Party Demographics 840, Product Attributes 850, Analytics Synthesizer 860, and State Change Service 870.

The State Change Dataset 810 includes a list of leads (i.e. consumers or businesses with qualified interest for a particular product) that have transitioned from state A to B where A is the start state and B is the end state. This data set includes attributes such as the campaign demographic (e.g. age bracket, retired) and geographic targets (e.g. Southeast) that stimulated the demand, user profiles and end-user profiles. This dataset might look like Table 1.

TABLE 1

| Campaign | User | End-user |
|---|---|---|
| Display and search | Demographic A | Demographic R |
| Southeast | (e.g. age, gender) | (e.g. age, gender) |
| | Category B | Category S |
| | (e.g. MA closer) | (e.g. soccer mom) |

The User Attributes 820 includes a set of users (e.g. sales agents) and their profile attributes. These attributes can include persistent information such as demographics (e.g. age, gender) and objective performance metrics (e.g. closes 80% of MA leads in Southeast). A profile might look like:

User: JDG, Zip: 80503, Gender: Male

Product A close rate for End-user Category R: 80%

Product B close rate for End-user category S: 70%

Product C close rate for End-user category T: 25%

The Campaign Attributes 830 includes the attributes associated with the campaign. This dataset might look like:

Campaign ID: 1234

Region: Southeast

Medium: Web (display, search)

Target: Families with young kids

Demographics: Income $R, DMA zones A, B, and C

Call to action: Click to Call or Chat

The 3^{rd} Party Demographics 840 originates from a third party service compiling various public data sources (e.g. census data) into a useable information source keyed by elements such as a zip code. The system 800 would utilize these datasets to predict or infer demographics for a particular lead opportunity in a particular zip code. For example, the geo information service ESRI predicts segmentation categories, race, gender, income, and home values. The following URL provides an example, expected profile for a lead in ZIP code 80503: http://www.arcwebservices.com/services/servlet/EBIS_Reports?service Name=FreeZip&zipcode=80503.

The Product Attributes 850 contains product attributes available to particular lead segments. The dataset might contain:

Product ID: 1234

Premium: $R

Feature A: Yes/No

Feature B: Yes/No

Feature C: Yes/No

The Analytics Synthesizer 860 would perform regression analysis for input data to determine the most reliable independent variables to predict probability of closure for a particular state. This prediction probability can take many forms such as an R-squared good fit test. The output of the synthesizer includes an algorithm for a service that responds to queries for state change probabilities and interface requirements (e.g. zip, product interest, campaign ID, state delta) for the State Change Service.

The State Change Service responds to queries for state change probabilities. The service will consume inputs such as a ZIP code, product interest, campaign ID and state change context and respond with a probability for closure. An example dialogue might be:

Query: 80503, Family Plan, IF001, A->B

Response: Probability R %

A consumer of the service could then use this information to decide whether the allocation of resources should occur given other, relative lead opportunities. For example, all lead opportunities with a 50% probably of closure get queued for processing only when opportunities with a greater probability do not exist or are in a wait state.

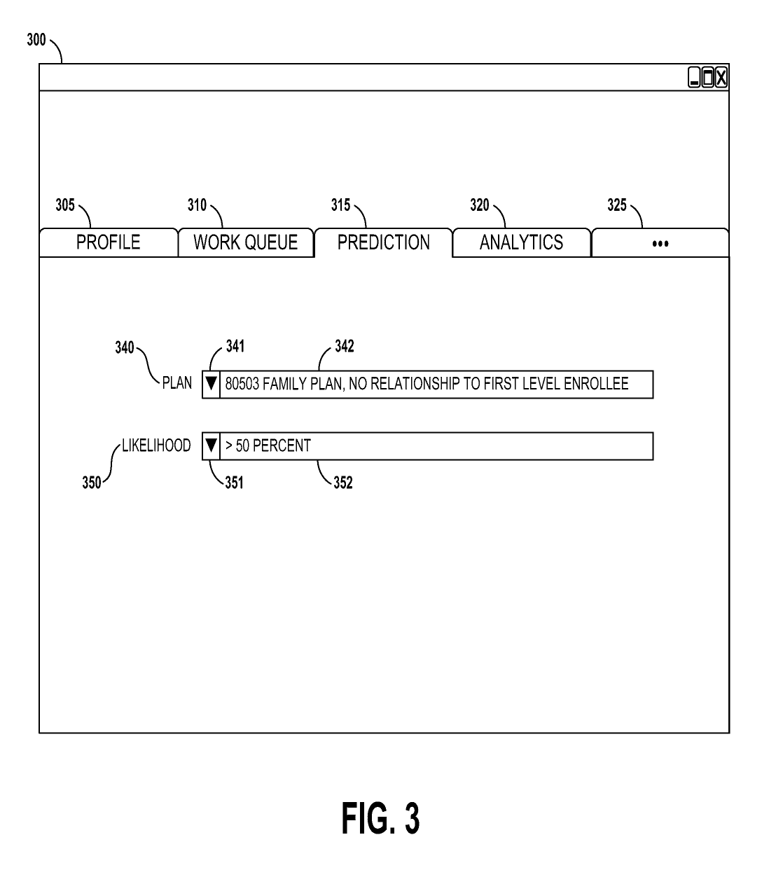

In one example of publishing the results, a sales agent or campaign manager may access the system to queue leads according to the probability to close the sale for a particular product or service as illustrated in FIG. 3—an exemplary user interface 300 serving as the desktop application for a sales agent. The interface includes a number of tabs for various modules including a profile module 305, a work queue module 310, a prediction module 315, an analytics module 320 and a variety of other modules 325 for use by the sales agent. In the window of the prediction module 315, the sales agent may select one of a number of services under the plan heading 340 by accessing a dropdown menu 341 containing a number of combinations of plans and state transitions including a combination entitled “80503 Family Plan, No Relationship to First Level Enrollee”. Based on the attributes of the family plan number 80503, the end user, and the population of sales leads, the correlative process set forth in FIG. 2 derives probabilities of success at step 260. In an embodiment, the user selects a threshold level of success within the prediction module 315, for example, under a likelihood heading 350, by accessing a dropdown menu 351 containing a number of threshold levels including a level 352 entitled “>50 Percent”.

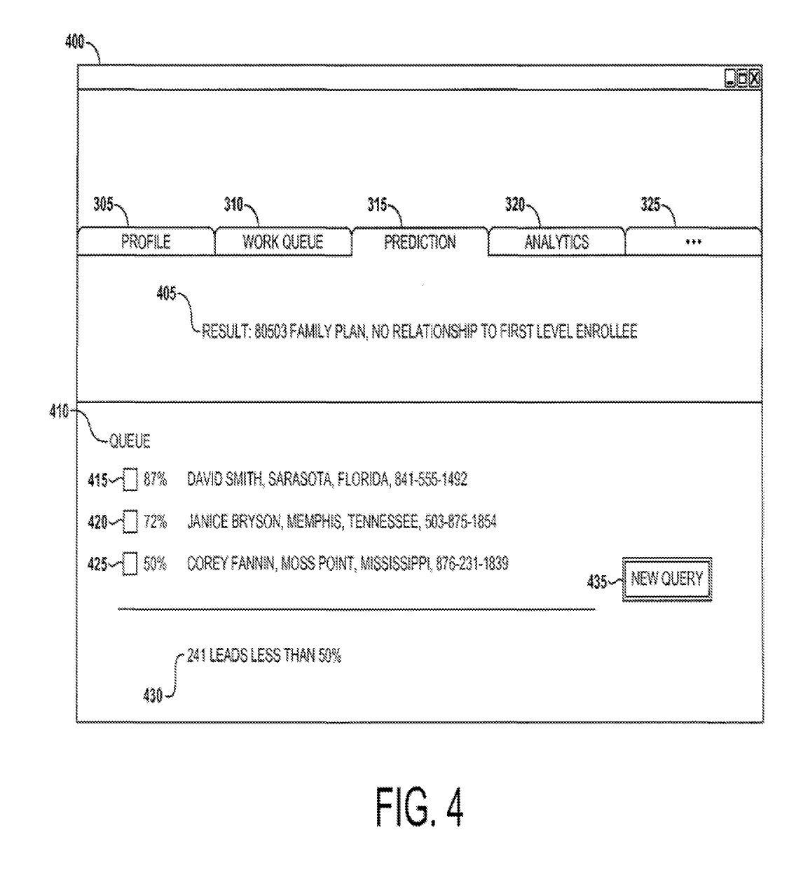

With reference to FIG. 4, in response to the selections made in FIG. 3, the system identifies leads with a probability of closure greater than 50% and presents the qualifying leads in a user interface 400. The query parameters are displayed under a heading 405, and a proposed queue 410 of those leads 415, 420, 425 exceeding the threshold likelihood of success are listed. In embodiments, these leads are simultaneously provided in the sales agents queue. Also, according to the correlations, the ideal activities for engaging with the lead are suggested when the sales agent is engaging with the lead. In other cases, the predictions are consumed by a workflow engine that assigns leads based on the absolute likelihood for a particular sales agent to close a sale or otherwise transition the state of the lead, or the relative likelihood of closing the sale in comparison to other sales agents so that the agent population may be most effectively utilized.

The findings of the process may be used for a variety of other valuable purposes. For example, in formulating the campaign, the correlation process may be used to define the market segments representing the greatest likelihood of success. Specifically, the target demographics and sales tasks and activities can be determined by correlating data of products with similar attributes and, in cases, analyzing the attributes of the sales agents. In one example, the sales tasks and activities will continuously improve by recommending additional products and sales based on the entire set of attributes described herein rather than a simplistic system that merely considers prior sales or one or two core demographics. Other marketing activities may be modified depending on the results including the triggering events (display, search, voice, mailings) and points of contact (toll free number, chart uniform resource indicator (URI), website URL, etc.).

In other embodiments, the system and method will provide campaign managers with better views into the impact of the campaign by analyzing individual transitions from one state to another based on the initial state of the lead rather than merely close rates. By analyzing the data at this level, lead populations having composite initial states with a disproportionate number of immature or mature leads will not improperly skew the analysis of the effectiveness and value of the sales activities. Likewise, in other embodiments, the systems and methods of the present invention will allow campaign managers to predict the likelihood of ultimately closing a sale based on the transition from earlier states in the sales process for like consumers.

Also, the correlations may be used to prioritize resource allocation between and among campaigns, products and market segments. In embodiments, the probability for closing a lead is further enriched by the short term and lifecycle value of closing the lead to evaluate the total expected return on investment. In other embodiments, the system and method of embodiments of the present invention is employed to determine the skill-based attributes of the sales agents most impactful on closing, and may be used for recruitment of certain sales agents to certain campaigns. Likewise, the system and method may be employed to sample and value whether additional data sources (and the cost associated with obtaining rights and infrastructure to access such sources) are justified in positive sales outcomes.

Additionally, as additional market segments are identified through the improvement of campaign targeting, user attributes will be enriched. For example, in embodiments, the sales agent attributes are further stratified to include close rates for products across more targeted segments than the initial data set.
CTI->Marketing Matrix Application

As companies pursue marketing campaigns, one challenge they face is matching an appropriate sales agent (system user) with an interested consumer who responds to a marketing initiative such as an on-line advertisement or print advertisement. For example, a company might contract with a Web-search-engine provider to display an ad whenever a consumer searches on a particular keyword that indicates possible interest in the company's product. Such an ad can include, for example, a “click-to-dial” icon that permits the consumer to call the advertiser to request further information or to purchase the advertised product. Such a “click-to-dial” icon is one example of what may be termed a “call-to-action trigger”—something that invites a consumer to contact the advertiser. Other examples of call-to-action triggers include, without limitation, a toll-free number in a print ad or a reply postcard that a consumer returns to the advertiser by mail.

As companies receive responses from consumers to such call-to-action triggers, they must decide how to route those marketing opportunities to sales agents, who then attempt to close a sale or at least move the consumers to a state that is closer to a sale (e.g., to accept a product demonstration or free trial). Conventional call-processing and sales-lead-management systems lack sophistication in routing marketing opportunities such as incoming calls or other responses to call-to-action triggers to appropriate sales resources (e.g., call-center agents or field agents). Conventional call-processing systems at call centers, for example, simply distribute incoming calls evenly among the available sales agents to balance call load. Conventional sales-lead-management systems route marketing opportunities (e.g., an interested consumer who returns a reply postcard) to field resources based simply on geography or on geography combined with availability/workload of the sales agents within a particular region.

The principles of the invention can be applied to the above routing problem to route marketing opportunities to sales agents more effectively than prior-art systems. In various illustrative embodiments, call-to-action activities (responses by consumers to call-to-action triggers) are tracked over time to produce a data set. That data set is analyzed using techniques such as regression analysis, as explained above, to identify which variables are most strongly correlated with transitioning particular types of consumers from one state to another desired state in the sales lifecycle. For example, such analysis can predict the probability that a particular sales agent will succeed in bringing about the desired state transition (e.g., from an inquiry to the closing of a sale) given the attributes of the particular consumer who is responding to the call-to-action trigger. Importantly, such analysis can also identify which sales agents are predicted to achieve a desired state transition with a specified probability of success. Such analytical data can be used to guide the operation of an intelligent routing system that routes marketing opportunities to sales agents (e.g., call agents or field agents) to maximize the rate at which sales are ultimately closed.

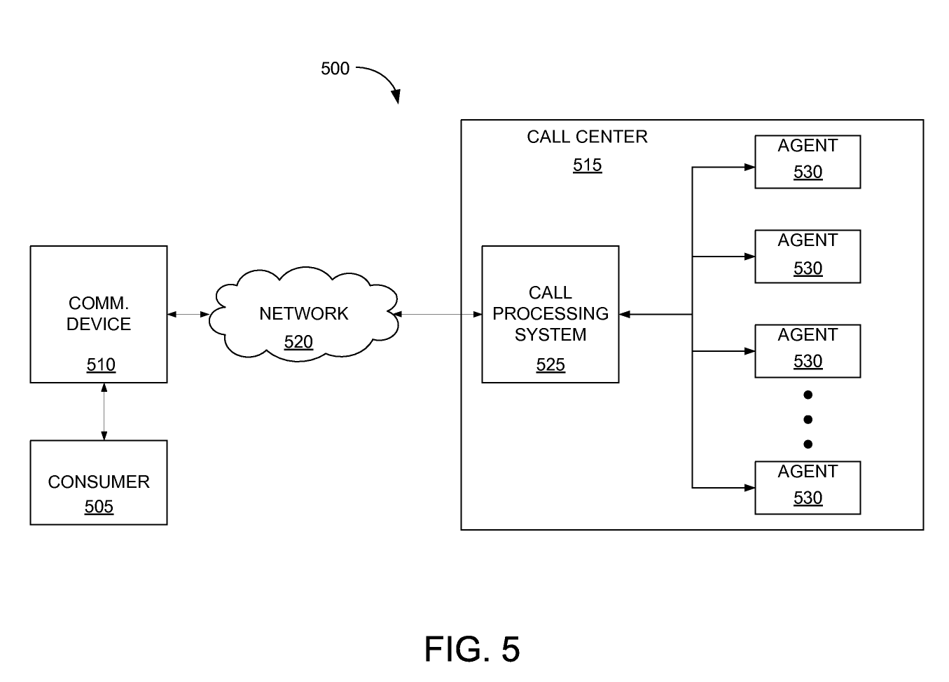

Referring next to FIG. 5, it is a high-level block diagram of an environment 500 in which certain embodiments of the invention can be implemented. More specifically, in environment 500, the marketing opportunities to be routed are incoming calls made by consumers in response to various call-to-action triggers. In this context, the term “call” is quite broad and can be any of a variety of different types of electronic communications such as, without limitation, a conventional telephone call over the public-switched telephone network (PSTN), a call placed using a wireless mobile device such as a cellular telephone, a voice-over-IP (VoIP) call, or a request to initiate a text-messaging (sometimes called a “live-chat”) session. For brevity, these different forms of real-time electronic communication are referred to, in the discussion below, as simply “calls.”

In FIG. 5, a consumer 505, in responding to a call-to-action trigger, uses a communication device 510 to contact call center 515. Communication device 510 can be a conventional landline telephone, cellular or other wireless telephone, personal digital assistant (PDA), computer, or other electronic communication device. Call center 515 includes call processing system 525 and a plurality of distinct sales agents 530. Agents 530 in FIG. 5 represent human sales agents as well as any associated communication equipment such as a telephone or computer that the sales agents use to receive incoming calls from consumers 505. Call processing system 525, which routes incoming calls to sales agents 530, receives the call from consumer 505 over network 520. As noted above, network 520 may include the PSTN, a cellular network, the Internet, or a combination thereof.

The specific design of call processing system 525 differs depending on the particular embodiment, but it includes intelligent computerized call-routing capabilities to be described in further detail below. For example, call processing system 525 can be implemented in part using one or more computers 100 such as that shown in FIG. 1, in combination with appropriate network and switching hardware such as a private branch exchange (PBX), gateway, or router. The primary difference between conventional call processing systems and call processing system 525 in FIG. 5 is the intelligence used to route incoming calls to specific sales agents 530.

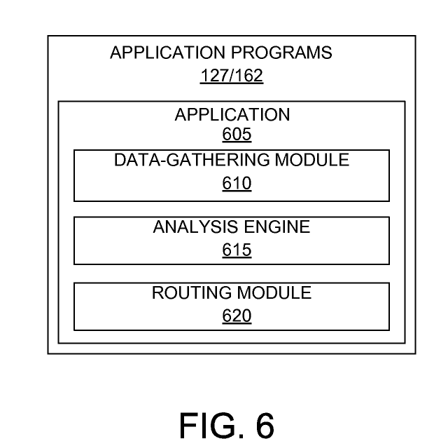

Referring next to FIG. 6, it is a diagram showing the architecture of an application 605 that performs a routing operation in accordance with an illustrative embodiment of the invention. In an illustrative embodiment, application 605 resides among application programs 127/162 in a computer 100 and is executed by a processor 110. Depending on the particular embodiment, application 605 may route incoming calls as part of call processing system 525, as discussed in connection with FIG. 5, or it may route other types of marketing opportunities that do not involve an incoming call. For example, in a particular context, it may be determined that the next step to be carried out with a particular consumer is for a sales agent to follow up with that consumer by contacting him or her. Such a situation constitutes one type of marketing opportunity to be routed (distributed) to a sales agent, possibly in the field.

Application 605 may be divided into various functional modules, as shown in FIG. 6. In other embodiments, application 605 may be divided into more or fewer functional modules, and the names of the modules could differ from embodiment to embodiment. In the embodiment illustrated in FIG. 6, application 605 includes data-gathering module 610, analysis engine 615, and routing module 620. Data-gathering module 610 gathers call-to-action-activity data by tracking call-to-action activities, as described above. This can include, for example, tracking the attributes or characteristics of consumers and those of the sales agents with whom they interact (see the discussion of such characteristics above), along with product-related information and information on how the consumers progress or fail to progress over time along the various states in the sales lifecycle. Data-gathering module 610 gathers this historical data for later use by analysis engine 615.

Analysis engine 615 takes the data set produced by data-gathering module 610 and analyzes it to infer marketing-opportunity-routing heuristics that can be used to increase the likelihood that a given marketing opportunity is converted into a sale or other desired outcome. Such analysis may include techniques such as regression analysis, as discussed above. Such regression analysis is used to determine which variables (e.g., consumer, sales-agent, and product characteristics) are the best predictors of whether a particular sales agent will succeed in transitioning a particular consumer from one state in the sales lifecycle to another. More specifically, such analysis can predict the probability that a particular sales agent with his or her particular set of attributes will succeed in bringing about the desired state transition (e.g., from an interested inquiry to the closing of a sale) given the attributes of the particular consumer who is responding to the call-to-action trigger. Such regression analysis can be used, for example, to identify which sales agents are predicted to achieve a desired state transition with a specified probability of success for a particular consumer.

The analytical data that analysis engine 615 produces can be used to create routing heuristics (or rules) for routing marketing opportunities to specific sales agents to maximize the probability of favorable state transitions (e.g., to the closing of a sale with a new customer or the generation of repeat business from previous customers). Routing module 620 uses such heuristics or rules to route marketing opportunities to sales agents. Some simple illustrative examples are provided below.

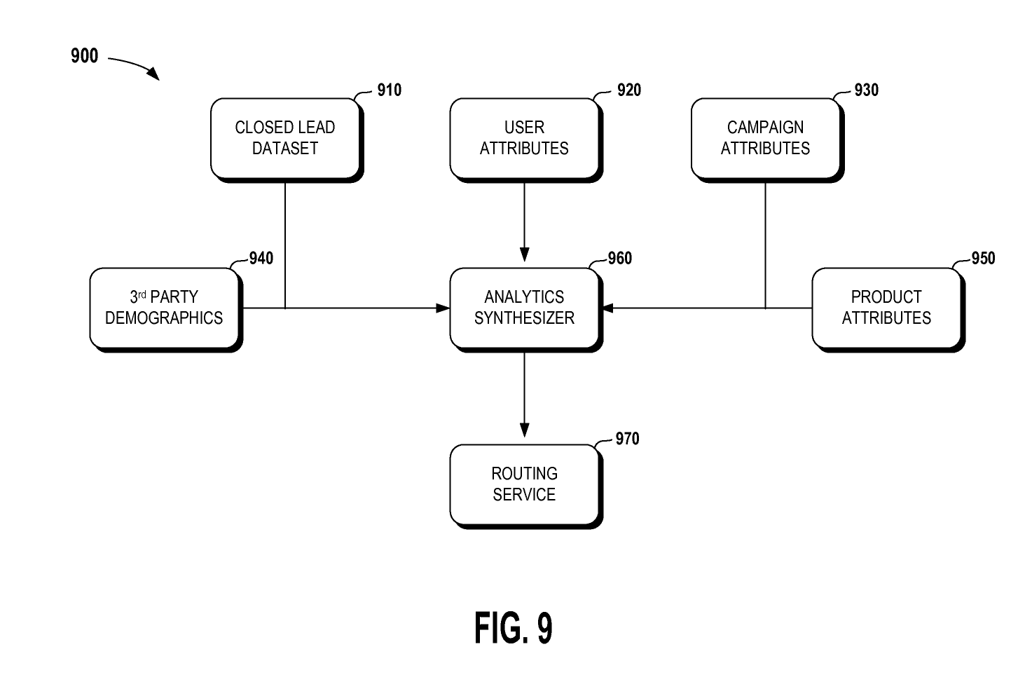

FIG. 9 illustrates in more detail the possible operation of an application 605 to generate analytics, including actionable intelligence synthesized from raw data captured through day-to-day business activity in accordance with an illustrative embodiment of the invention. Synthesized analytics might include market segmentation recommendations, co-variance results matching particular derived end-user profiles, campaign attributes (e.g. segmentation, performance) and user performance metrics, and segmentation prioritization to maximize target-operating metrics (e.g. enrollments). By way of example, a system 900 as shown in FIG. 9 demonstrates the analysis of state conditions (e.g. closed sales) to understand the behaviors that triggered the state. This behavioral analysis synthesizes independent variables that a system can utilize to predict a particular state or select users that should be assigned to particular objects (e.g. sales leads). The system 900 consists of a Closed Lead Dataset 910, User Attributes 920, Campaign Attributes 930, 3^{rd} Party Demographics 940, Product Attributes 950, Analytics Synthesizer 960, and Routing Service 970.

The Closed Lead Dataset 910 includes a list of leads (i.e. consumers or businesses with qualified interest for a particular product) that have selected and enrolled in a particular product. The dataset includes attributes such as the campaign demographic (e.g. age range, retired) and geographic targets (e.g. Southeast), user profile and end-user profile. The Closed Lead Dataset 910 might look like:

TABLE 2

| Campaign | User | End-user |
|---|---|---|
| Display and search | Demographic A | Demographic R |
| Southeast | (e.g. age, gender) | (e.g. age, gender) |
| | Category B | Category S |
| | (e.g. MA closer) | (e.g. soccer mom) |

The User Attributes 920 includes a set of users (e.g. sales agents) and their profile attributes. These attributes can include persistent information such as demographics (e.g. age, gender) and objective performance metrics (e.g. closes 80% of MA leads in Southeast). A profile might look like:

User: JDG, ZIP: 80503, Gender: Male

Product A close rate for End-user Category R: 80%

Product B close rate for End-user Category S: 70%

Product C close rate for End-user Category T: 25%

The Campaign Attributes 930 includes the attributes associated with a campaign. This dataset might look like:

Campaign ID: 1234

Region: Southeast

Medium: Web (display, search)

Target: Families with young kids

Demographics: Income $R, DMA zones A, B and C

Call to action: Click to Call or Chat

The 3^{rd} Party Demographics 940 originates from a third party service compiling various public data sources (e.g. census data) into a useable information source keyed by elements such as a ZIP code. The system 900 would utilize these datasets to predict or infer demographics for a particular lead opportunity in a particular zip code. For example, the geo information service ESRI predicts segmentation categories, race, gender, income, and home values. The following URL provides an example, expected profile for a lead in zip code 80503: http://www.arcwebservices.com/services/servlet/EBIS_Reports?serviceName=FreeZip&zipcode=80503.

The Product Attributes 950 contains product attributes available to particular lead segments. The dataset might contain:

Product ID: 1234

Premium: $R

Feature A: Yes/No

Feature B: Yes/No

Feature C: Yes/No

The Analytics Synthesizer 960 would perform regression analysis for input variables and datasets and derive reliable independent variables that predict probability of closure for a particular end-state and the type of user that should be assigned to the opportunity object to ensure this probability. The output of the synthesizer includes dynamic routing rule sets, interface requirements (e.g. zip, product interest, campaign ID) and responses to queries.

The Routing Service 970 responds to queries for lead routing assignments. The Routing Service will consume inputs such as a zip code, product interest and campaign ID and respond with user assignment suggestions. An example dialogue might be:

Query: 80503, Family Plan, IF001

Response: User A, User B or User C for probability R %

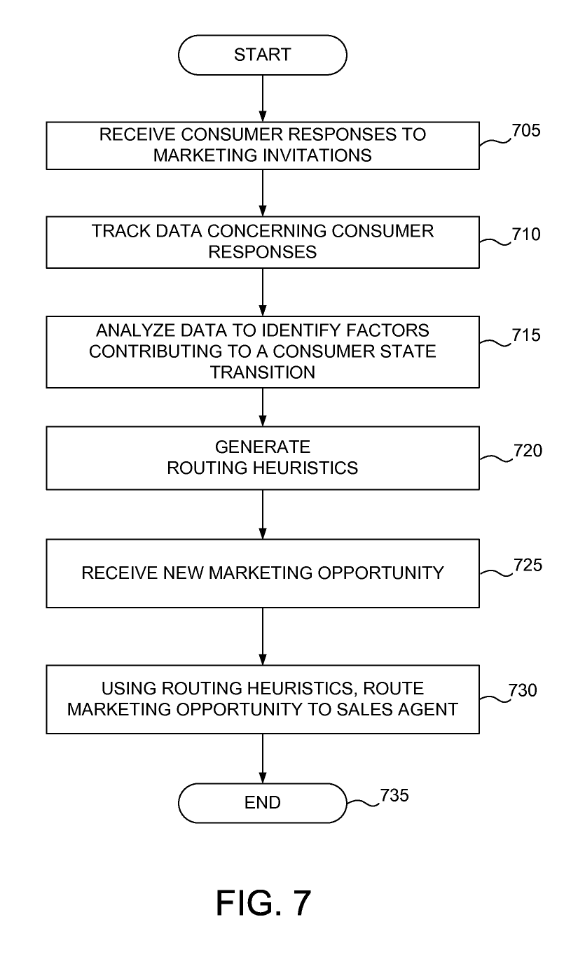

Referring next to FIG. 7, it is a flowchart of a method for routing a marketing opportunity to a sales agent in accordance with an illustrative embodiment of the invention. At 705, a company receives consumer responses to marketing invitations it has previously made. In embodiments, such marketing invitations are in the form of call-to-action triggers. For example, the consumer responses might be responses to a Web advertisement prompting young consumers to consider a health care plan and inviting them to click on a “click-to-chat” icon for further details. Other call-to-action triggers could include, without limitation, a toll-free number to call, an on-line or hardcopy survey, or a reply postcard that the consumer mails to the advertiser. Call-to-action triggers are normally designed to make it easy for the company to identify to which specific campaign a consumer is responding. For example, an on-line “call-to-chat” icon may link to a unique URL, and a print ad can include a specific toll-free number that is uniquely mapped to the particular campaign.

At 710, data-gathering module 610 tracks call-to-action activities—responses by consumers to the call-to-action triggers, as discussed above. Such tracking is unique to various embodiments of the invention because it compiles, organizes, and stores data that would normally be scattered among disparate systems such as telecommunications switches (e.g., caller-ID data for incoming calls), computers managing sales-lead databases, third-party databases containing demographic and economic data, etc.

At 715, analysis engine 615 analyzes the data gathered by data-gathering module 610 to identify factors contributing to a consumer state transition. Such analysis can involve applying techniques such as regression analysis to a situation in which a particular consumer with certain characteristics (e.g., gender, geographic location, income, etc.) transitioned from State A to State B to determine what the most likely factor or factors were that led the consumer to make the desired state transition.

At 720, routing heuristics for routing marketing opportunities are generated. The factors identified as influential in the consumer state transition, including factors related to sales-agent identity and attributes, can be codified in these heuristics or rules and applied to new marketing opportunities to predict how likely a particular sales agent is to transition a particular consumer from one state to another desired state. In that manner, the best sales agent or agents can be identified to which to route a marketing opportunity. In short, application 605 makes predictions based on what has worked in the past to transition particular types of consumers and uses that information to intelligently route marketing opportunities to sales agents in the present.

At 725, application 605 identifies a marketing opportunity that needs to be routed to a sales agent. Such identification, in some embodiments, includes recognizing that a responsive call is being received from a particular consumer (recall that “call,” in this context, refers to a real-time electronic communication of some kind). In other situations, a kind of marketing opportunity other than an incoming call is identified, as discussed above.

At 730, routing module 620 uses the routing heuristics derived from the tracked call-to-action-activity data to route the identified marketing opportunity to a specific sales agent. Such selection of a sales agent maximizes the probability that the consumer will transition to a desired state, such as the closing of a sale. At 735, the process terminates.

As those skilled in the relevant art are aware, there are a number of variables that can influence how a particular consumer responds to a particular sales agent. Some of these, without limitation, include gender, location (i.e., whether the sales agent is from another country or not), regional accents or dialects, education level, product knowledge, and age. For example, analysis engine 615 might determine that a well-educated person from the Chicago area contacting a call center 515 in response to a call-to-action trigger generally does not respond well to a call-center agent who speaks in slang or with a southern accent. The inference that a caller is well educated and from Chicago can, for example, be based on an analysis by routing module 620 of the caller's number, as revealed by caller ID. Third-party database services such as the ESRI GEO PORTAL provided by ESRI Inc. can predict a consumer's gender, race, income, education level, home value, etc., based on the caller's ZIP code, which can be determined from the consumer's identified phone number. As discussed above, other third-party information sources can also be used to acquire additional information about the attributes of consumers.

Based on the analysis of the historical call-to-action-activity data output by data-gathering module 610, routing module 620 can use the routing heuristics generated by analysis engine 615 to route a call from the well-educated consumer in the Chicago area to a sales agent whose attributes are compatible with that profile and who, based on the available heuristics, has the highest predicted probability of bringing about the desired state transition for that particular consumer. Note that such intelligent routing can be performed before the call is answered.

For example, the following algorithm demonstrates how a system can assign or route an opportunity with an active event such as an incoming phone call to a type of agent in a way that maximizes the probability of a desired outcome. In this use case, the desired outcome is a closed sale event, an agent category is defined by Location, Age Band, Gender, Language and Product Expertise and an event is defined by Lead Source, Campaign Type, Product Interest, Consumer Gender and Consumer ESRI. Using a baseline set of historical, closed sales events, the system codifies a predictor formula and uses characteristics of active events to derive the best agent to process the event. An agent begins work on an event when the system routes or assigns the event to the agent.

The algorithm begins by defining agent categories or segments. Agents are segmented into categories characterized with attributes such as location, age band, gender and expertise, and each Agent Category is assigned an ID. Each agent may also have a presence attribute that indicates busy or available to process or work an event. An agent segmentation may look as follows:

| Agent | | Age | | | Product |
|---|---|---|---|---|---|
| Category | Location | Band | Gender | Language | Expertise |
| 1 | 32808 | 30-39 | Male | Spanish | Over 65 plans |
| 2 | 28027 | 50-59 | Female | English | Group plans |
| 3 | 47130 | 40-49 | Male | Spanish | Under 65 |
| | | | | | plans |
| . . . | | | | | |

Next, the algorithm sets a baseline predictor of ideal agent categories by normalizing a baseline data set of closed sales for a select period of time, with Agent Categories defined in step 1 as a dependent variable and Lead Source, Campaign Type, Product Interest, Gender and ESRI Segment as independent variables. The data set includes all closed sale events and the independent variables associated with the events. Multiple linear regression is then performed to derive the predictor, which is expressed as y=b₀+b₁(Source)+b₂(Campaign)+b₂(Product)+b₃(Gender)+b₄(ESRI). The data set may look as follows:

| Dependent | | | | | |
|---|---|---|---|---|---|
| Variable | Independent Variables | | | | |
| Agent | | Campaign | Product | | |
| Category | Lead Source | Type | Interest | Gender | ESRI |
| 1 | Web | Email West | O65 | Male | 07 |
| | abandon | | | | |
| 2 | Finder filer | Print East | U65 | Female | 02 |
| 3 | Search | Search US | Group | Unknown | 13 |
| | engine | | | | |
| 2 | Web | Email West | U65 | Male | 21 |
| | abandon | | | | |
| . . . | | | | | |

The algorithm then determines a context for an active event—for example, an incoming call to a Toll Free Number linked to a print campaign. This involves determining the Lead Source or Campaign Type, determining Product Interest for the Campaign Type (e.g. Over 65 plans), determining Gender through voice recognition or prior known attributes (e.g. attributes in the system), determining ZIP using prior known attributes from the system, determining ESRI Tapestry Segmentation for the consumer via a web service using the ZIP as an input, and predicting the best Agent Category for the event using the predictor derived above.

Finally, the algorithm assigns the lead and sets activities. With an ideal Agent Category to convert the event, the system assigns the opportunity to users in the system. The assignment algorithm may consider factors such as the current Presence attribute and load balancing parameters for pools of Agent Categories. Load balancing can distribute evenly or in a weighted fashion; for example, 10 events might go evenly to 5 agents, or 1 agent may receive 6 events and the remaining 4 agents may receive 1 event each.

In some embodiments, other variables or attributes can be taken into account in addition to or instead of those mentioned above. For example, if a consumer contacts call center 515 for the second time to lodge a complaint (application 605 can easily determine that the consumer has called before from the stored historical data), application 605, in some embodiments, includes algorithms for recognizing that the caller is female and that the caller sounds stressed or angry. Techniques for identifying the gender and emotional state of speakers are well-known in the art. Based on the stored heuristics produced by analysis engine 615, routing module 620 can route the call to a specific sales agent who, based on the analyzed historical data, is expert at handling such stressed or angry callers.

Another variable or attribute that can be taken into account is the mode of communication used to interact with the consumer. For example, analysis engine 615 might determine, in a particular embodiment, that text messaging is the best way to communicate with a particular type of consumer to maximize the close rate. As a further example, analysis engine 615 might determine that the best way, historically, to handle a consumer's text message inquiring about a product is to respond in kind (i.e., with a reply text message) or, instead, with a conventional telephone call. With variables such as the mode of communication, it is possible and even advantageous, in some embodiments, to normalize the collected consumer data. That is, “rules of thumb” can be inferred from the collected call-to-action-activity data for dealing more effectively with particular groups of consumers (e.g., females between 18 and 25 respond better to text messages than to phone calls).

Note that analysis such as that described above in connection with analysis engine 615 can also be used to improve the workflow a sales agent employs in dealing with consumers. For example, the analysis might reveal that, in a set of workflow process steps A, B, C, D, E, and F, it is better to omit E and F because they merely annoy the consumer and reduce the close rate.

In various illustrative embodiments, the routing heuristics or rules discussed above are adaptive. That is, they are continually updated as data-gathering module 610 acquires further data and analysis engine 615 analyzes it. From one day to another during a given marketing campaign, marketing opportunities may be routed differently based on the updated routing heuristics.

In conclusion, the present invention provides, among other things, a system and method for routing marketing opportunities to sales agents. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention.

What is claimed is:

1. A system for routing marketing opportunities to sales agents, the system comprising:
at least one processor, and
a memory connected with the at least one processor, the memory containing a plurality of program instructions configured to cause the at least one processor to:
receive a plurality of consumer responses to marketing invitations;
track, in a database, attributes of the consumers associated with the plurality of consumer responses, attributes of a plurality of sales agents with whom the consumers interact, product-related attributes, and transitions of the consumers among a plurality of consumer states, each of the plurality of consumer states corresponding to a particular situation in a sales lifecycle;
identify, by analyzing information in the database, one or more factors that contributed to at least one transition;
generate one or more routing rules based on the one or more factors;
receive a new consumer response to a marketing invitation; and
route the new consumer response to a particular sales agent among the plurality of sales agents based on the one or more routing rules.

2. The system of claim 1, wherein the one or more factors that contributed to at least one transition are identified using a regression analysis.

3. The system of claim 2, wherein the at least one transition is a dependent variable in the regression analysis.

4. The system of claim 2, wherein an agent category is a dependent variable in the regression analysis, the agent category comprising a subset of the plurality of sales agents, each sales agent in the subset of the plurality of sales agents having at least one common attribute.

5. The system of claim 1, wherein the plurality of program instructions are further configured to cause the at least one processor to obtain additional information about the new consumer response based on at least one known piece of information about the new consumer response.

6. The system of claim 5, wherein the at least one known piece of information about the new consumer response is a consumer telephone number and the additional information about the new consumer response is at least one of a consumer ZIP code, a consumer gender, a consumer income, a consumer education level, and a consumer home value.

7. The system of claim 1, wherein the plurality of program instructions are further configured to cause the at least one processor to analyze the new consumer response in real-time to predict additional information about the new consumer response.

8. The system of claim 7, where the additional information about the new consumer response is at least one of a consumer gender and a consumer emotional state.

9. The system of claim 1, wherein the new consumer response is a real-time electronic communication.

10. The system of claim 1, wherein the attributes of a sales agent in the plurality of sales agents include at least one of a sales agent nationality, a sales agent accent, a sales agent education level, a sales agent product knowledge level, a sales agent age, a sales agent gender, and a sales agent ZIP code.

11. The system of claim 1, wherein the attributes of a consumer include at least one of a consumer gender, a consumer geographic location, a consumer income, a consumer race, a consumer education level, a consumer emotional state, and a consumer home value.

12. The system of claim 1, wherein the plurality of program instructions are further configured to cause the at least one processor to track, in a database, the mode of communication used by a sales agent to interact with the consumer associated with each of the plurality of consumer responses.

13. The system of claim 12, wherein the plurality of program instructions are further configured to cause the at least one processor to suggest to the particular sales agent a particular mode of communication for interacting with the consumer associated with the new consumer response.

14. A method for routing marketing opportunities to sales agents, the method comprising:
receiving a plurality of consumer responses to marketing invitations;
tracking, in a database stored in a memory, attributes of the consumers associated with the plurality of consumer responses, attributes of a plurality of sales agents with whom the consumers interact, product-related attributes, and transitions of the consumers among a plurality of consumer states, each of the plurality of consumer states corresponding to a particular situation in a sales lifecycle;
identifying, by using a processor to analyze information in the database, one or more factors that contributed to at least one transition;
generating one or more routing rules based on the one or more factors;
receiving a new consumer response to a marketing invitation; and
routing the new consumer response to a particular sales agent among the plurality of sales agents based on the one or more routing rules.

15. The method of claim 14, wherein the one or more factors that contributed to at least one transition are identified using a regression analysis.

16. The method of claim 15, wherein the at least one transition is a dependent variable in the regression analysis.

17. The method of claim 15, wherein an agent category is a dependent variable in the regression analysis, the agent category comprising a subset of the plurality of sales agents, each sales agent in the subset of the plurality of sales agents having at least one common attribute.

18. The method of claim 14, further comprising obtaining additional information about the new consumer response using at least one known piece of information about the new consumer response.

19. The method of claim 18, wherein the at least one known piece of information about the new consumer response is a consumer telephone number and the additional information about the new consumer response is at least one of a consumer ZIP code, a consumer gender, a consumer income, a consumer education level, and a consumer home value.

20. The method of claim 14, further comprising tracking, in the database stored in the memory, the mode of communication used by a sales agent to interact with the consumer associated with each of the plurality of consumer responses.

21. The method of claim 20, further comprising suggesting to the particular sales agent a particular mode of communication for interacting with the consumer associated with the new consumer response.

22. A computer-readable storage medium containing a plurality of program instructions for execution by a processor, the plurality of program instructions being configured to:
receive a plurality of consumer responses to marketing invitations;
track, in a database, attributes of the consumers associated with the plurality of consumer responses, attributes of a plurality of sales agents with whom the consumers interact, product-related attributes, and transitions of the consumers among a plurality of consumer states, each of the plurality of consumer states corresponding to a particular situation in a sales lifecycle;
identify, by using a processor to analyze information in the database, one or more factors that contributed to at least one transition;
generate one or more routing rules based on the one or more factors;
receive a new consumer response to a marketing invitation; and
route the new consumer response to a particular sales agent among the plurality of sales agents based on the one or more routing rules.
